(19) United States
(12) Patent Application Publication
(10) Pub. No.: US 2006/0157656 A1
(43) Pub. Date: Jul. 20, 2006

(54) Multi-radiation source-ferroelectric-based source of plurality of radiation types

(76) Inventors: Yoseph Bar-Cohen, Seal Beach, CA (US); Stewart Sherrit, Glendale, CA (US); Yakov E. Krasik, Nesher (IL); Joshua Felsteiner, Haifa (IL); Xiaoqi Bao, San Gabriel, CA (US)

Correspondence Address: Yoseph Bar-Cohen, 3721 Fuchsia Street, Seal Beach, CA, 90740, US

(21) Appl. No.: 11/035,447

(22) Filed: Jan. 14, 2005

(51) Int. Cl. G21G 4/00

(52) U.S. Cl. 250/493.1

(57) ABSTRACT

The present invention provides a source of plurality of radiation types using a single source that is made of ferroelectric material in the form of a cathode. The generated radiation types consist of ion and electron beams, X-ray, visible light and ultraviolet radiation. These types allow testing the surface and bulk of the same medium while placed in the same location and are providing confirmation and independent measurements of the material properties. The cathode is made with a continuous electrode on one side and a grid shape electrode on the other. This cathode is supported with fixtures that are used to produce various radiation types. Also, control elements are used to define the shape and directivity of the emitted beam. The present invention eliminates the need for plurality of instruments for obtaining required properties of test materials covering both the surface and the bulk of the test medium. The disclosed source emits multiple types of charged particles and radiation using switchable electromechanical elements. The source performance is enhanced by use of a ferroelectric wafer with a high dielectric constant, and the control of the driving pulse shape. A set of stacks and arrays of multiplexed ferroelectric cathode wafers are used to offer various options in the design of the Ferrosource.

### STATEMENT REGARDING FEDERALLY SPONSORED RESEARCH

The U.S. Government has a paid-up license in this invention and the right in limited circumstances to require the patent owner to license others on reasonable terms.

### BACKGROUND OF THE INVENTION

1. Field of the Invention

The present invention relates to material analysis devices that are used for such fields as planetary exploration, military, construction, criminology, geology, archeology, homeland defense, chemistry, and ecology. The disclosed device generates plurality of radiation types using the plasma that is formed by ferroelectric disks subjected to high electric field and are made with a grid electrode on one side and a continuous electrode on the other side. The disclosed source generates five types of radiation and they consist of ion and electron beams, X-ray, visible light and ultraviolet. These radiation types can support such analyzers as Computer Aided Test (CAT) scanners, X-ray diffractometers, X-ray fluorescence spectrometers, ultraviolet biofluorescence spectro-meters, and visible reflectance spectrometers.

2. Background of the Invention

Many material analysis techniques require a source that emits radiation with known characteristics that illuminates the tested material. The transmitted or reflected radiation is detected by various types of sensors depending on the radiation that is used and the material that is being tested. In many cases, the use of a single test technique is not sufficient for the determination of the desired properties of the test medium and the application of plurality of test instruments is required. The use of plurality of instruments is costly, involves excessive number of parts and their combination as a system is relatively heavy, consumes extensive power and has large volume. The disclosed Multi-Radiation Source emits a plurality of electromagnetic and charged particle radiation types that are generated by a single source. This source allows testing the surface and bulk of the same material that is placed at a known position, providing independent measurements. The integrated apparatus that is based on the disclosed Multi-Radiation Source is designed as a compact, lightweight, and low-power system with minimal number of components. Also, this single multi-radiation source minimizes the need to transport the test material from one analyzer to another, and therefore eliminates the need for related manipulation mechanisms and reduces potential contamination.

Existing sources of charged particles, ultraviolet and visible light as well as X-rays are large, heavy and require complicated power supplies that consume high power levels. Electron and ion beams can be produced by field emission, or thermionic emission. However, existing sources require extremely high electric fields or heating power supplies with ultrahigh and clean vacuum, respectively. Alternatively, one can use plasma sources, but most plasma sources require power supplies, with sophisticated triggering schemes and complex support elements. Sources of electrons are used in almost all electronic devices that produce radio frequency, microwave, X-radiation and visualization of objects. Over the past three decades there has been a significant progress in the development of sources of generating electron beams. Such sources can now create current amplitudes 10³-10⁷ A, with electron energies of 10⁴-10⁷ eV at 10⁻⁹-10⁻⁵s pulse duration. The main requirements for these electron sources are as follows:
1. emit simultaneously with the application of the accelerating voltage pulse.
2. extracted electron current density are governed by the space-charge law and not by the emission properties of the source.
3. extracted electron current density needs to be uniform in its cross-sectional area.
4. reliable and reproducible.
5. suitable for operation in vacuum of 10⁻²-10⁻⁸ Torr.

Generally, electron sources can be divided into two groups: passive and active. Passive sources are considered those that emit electrons only under the application of an accelerating pulse. The operation of the passive sources is based on field emission, thermionic emission, and/or explosive emission phenomena. On the other hand, active electron sources are those that produce plasma prior to the application of the accelerating pulse allowing control of the plasma parameters. By adjusting the plasma electron density and temperature it is possible to achieve equality between the plasma charged particles saturation current density and the current density predicted by the space-charge law. This law determines the current density of the charged particles that is extracted from the plasma.

Application of field emission and explosive emission plasma cathodes for production of high-current electron beams is highly problematic because of the need for high accelerating electric fields (>10⁷ V/cm). These fields cause the formation of explosive emission plasma on the cathode surface. In addition, electron field emission and thermionic emission require high vacuum (10⁻⁷-10⁻⁹ Torr), which is very difficult to achieve in high-current diodes. Also, one has to take into account the necessity for a high-current power supply for the heating of the thermionic cathode. It is important to note that the thermionic emission has several severe drawbacks including: time delay in the plasma formation with respect to the start of accelerating pulse, plasma non-uniformity, and fast plasma expansion due to the large plasma density and temperature gradients. The latter leads to non-linear behavior of the diode impedance and a limited duration of the accelerating pulse because the plasma causes a short along the anode-cathode gap. In addition, obtaining a long lifetime of explosive emission cathode and its compatibility with vacuum are still highly questionable.

The disclosed Multi-Radiation Source is based on ferroelectric cathode that is an active plasma cathode that generates current densities of up to 100 A/cm² with repetition rates of up to several tens of Hz. Data show that the parameters of the electron beam generated in a diode with a ferroelectric plasma cathode allows one to avoid problems of time delay in appearance of electron emission and to control the parameters of the electron diode and the generated electron beam.

The disclosed device is a single source with controllable emitted radiation that are selected by intermediate support fixtures and it can be used to test the same area of materials via different analyzers and thus enhancing the amount of information and accuracy of the analysis that can be achieved. Since the disclosed Multi-Radiation Source is based on ferroelectric materials it can operated at extreme environments ranging from very cold to very hot temperatures that are determined by the specific material that is used as a source. The disclosed source has a modality that consists of an array allowing high reliability of operation where failure of one element in the array will not cause a system failure. Another modality consists of plurality of disks that are connected to produce intense radiation.

It is the object of this invention to provide multiple radiation types using a single source. In addition, it is the object of this invention to provide an apparatus that is lightweight, compact and consumes low power. Further, it is the object of this invention to provide information about the surface and the bulk of test material that can operate at low and high temperatures and plurality of pressure levels.

### SUMMARY OF THE INVENTION

This invention consists of a ferroelectric cathode that generates several radiation types that consist of ion and electron beams, X-ray, visible light and ultraviolet radiation. The generated radiation types allow testing the surface and bulk of the same material while placed in the same location and are provide confirmation and independent measurement of the material properties. The disclosed single source has additional two modalities consisting of an array and several ferroelectric cathode disks for high reliability preventing the dependence on the operation of a single element. The increased reliability results from the use of redundant elements in case of a single element failure.

Alternative materials analyses that use multiple types of radiation consist of separate instruments and require extensive number of components. They are heavy, large and consume significant power levels. Further, they need a complex manipulation system for transferring the test samples from one instrument to another subjecting them to potential contamination along the way.

The disclosed source is based on the ability of ferroelectric disks to produce plasma. A ferroelectric wafer with a continuous ground electrode on one side and a grid-shaped electrode on the other side generates plasma when subjected to voltage pulses. This occurs as a result of an incomplete discharge on the surface covered by the grid-shaped electrode. For maximized radiation emission, the ferroelectric disk is made of a material with high dielectric constant. The source of radiation is driven by electronic driver that provides signal shaping for maximization of the emission efficiency and the control of the beam characteristics. Optical and electronic focusing and collimation system are used to control the beam directivity characteristics.

### BRIEF DESCRIPTION OF THE DRAWINGS

This invention will be more understood from the following detailed description of representative embodiments thereof read in conjunction with the accompanying drawings wherein:

FIG. 1 is schematic view of a ferroelectric disk that is configured as a cathode source that produces plasma.

FIG. 2 is schematic diagram of the radiation source, emitted electron beam and the target metal for emission of X-rays

FIG. 3 is schematic diagram of the drive electronics that activates the source to produce plasma on the ferroelectric disk

FIG. 4 is showing a schematic of a plurality of parallel ferroelectric cathode disks with electrodes and a collective grid.

FIG. 5 is showing a schematic of a plurality of ferroelectric cathodes on a single disk with an electrode array.

FIG. 6 is schematic diagram of the radiation types that are emitted by the disclosed source and examples of measurement instruments that use the emitted radiation.

FIG. 7 is one embodiment perspective view of this multi-radiation source invention.

### DETAILED DESCRIPTION OF THE PREFERRED EMBODIMENT

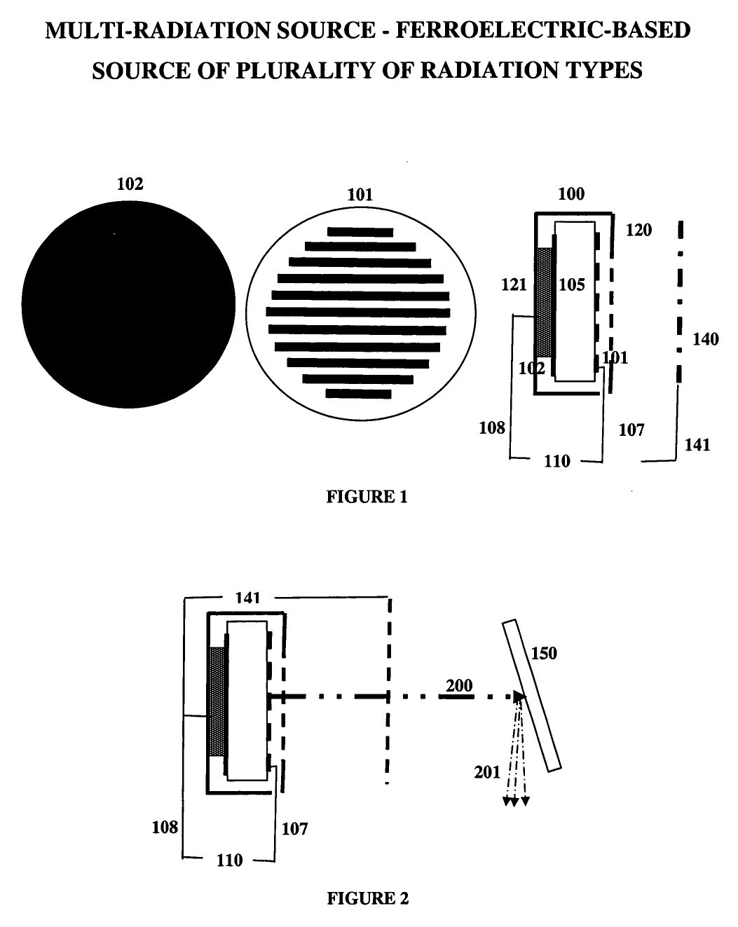

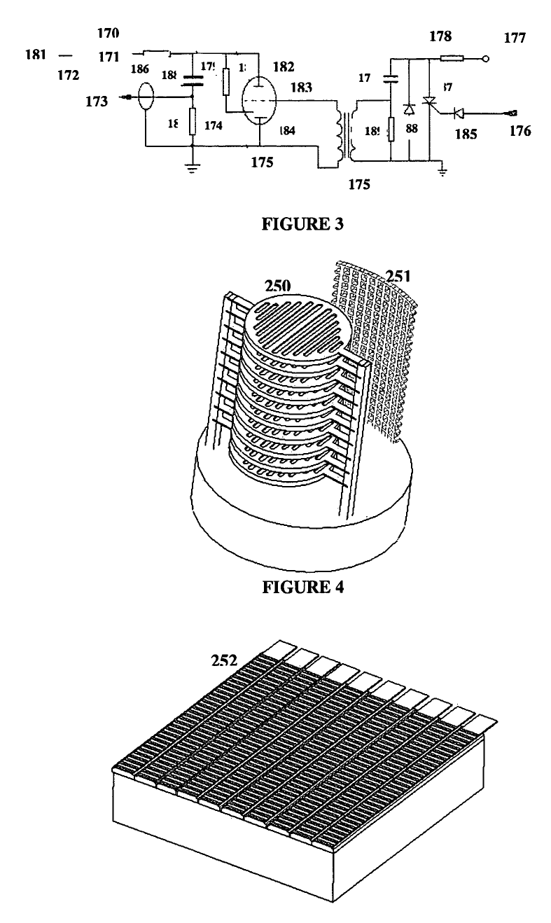

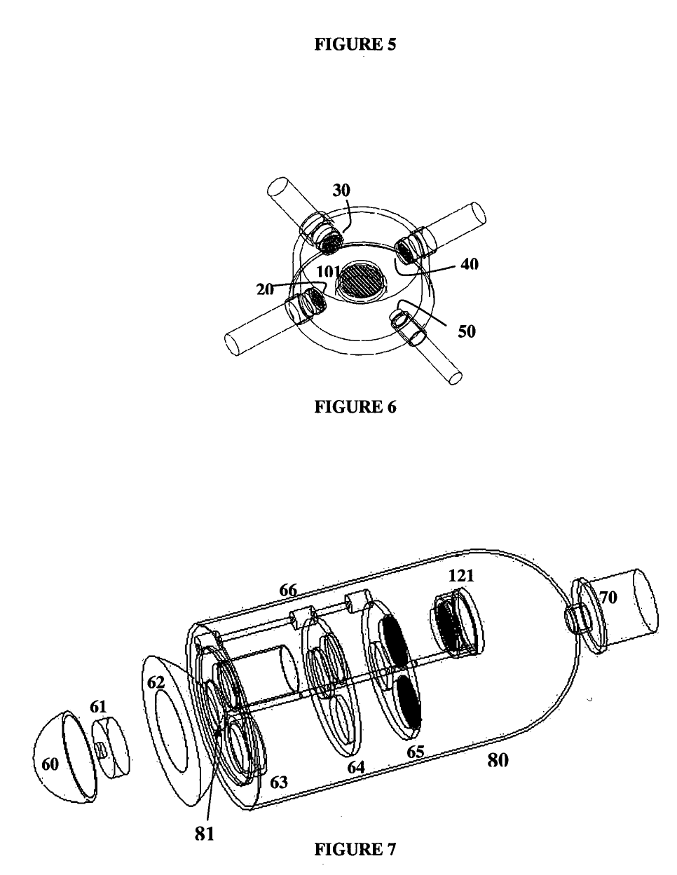

In the following description of the preferred embodiment, reference is made to the accompanying drawings, which form a part thereof, and in which by way of illustration, a specific embodiment in which the invention may be practiced. It is to be understood that other embodiments may be utilized and structural changes may be made without departing from the scope of the present invention. FIG. 1 is showing a schematic view of the ferroelectric cathode that is used to produce plasma and it is the key to this invention. FIG. 2 is showing a schematic diagram of the radiation source, an emitted electron beam that is one of the types of radiations and a target metal for emission of X-rays. FIG. 3 is showing the circuit diagram of the drive electronics that activates the source to produce plasma on the ferroelectric disk. FIG. 4 is showing a schematic of a plurality of parallel ferroelectric cathode disks with electrodes and a collective grid. FIG. 5 is showing a schematic of a plurality of ferroelectric cathodes on a single disk with an electrode array. FIG. 6 is showing schematic diagram of the radiation types that can be generated using the produced plasma and examples of measurement instruments that use the generated radiation types. FIG. 7 is an embodiment of the disclosed Multi-Radiation Source in the present invention and a view of the components of the disclosed apparatus.

Turning now to FIG. 1, embodiment 100 presents the core of the Multi-Radiation Source invention. This embodiment consists of ferroelectric-disk 105 that has continuous electrode 102 on one side and a grid shape electrode on the other side 101. The produced dense surface plasma at the electrode with the grid shape 101 is generated by the application of a driving voltage pulse 110 that is several tens of nanoseconds duration and relatively small amplitude of several killoVolts. The disk 105 can be made in diameters and thickness that can range from several millimeters to several centimeters. The selected diameter is as small as 4 times the thickness and as large as several tens of times the thickness. The grids 101 can have many modality including linear strips, circles, and ellipsoidal shapes. Using the high dielectric constant of ferroelectric materials 105 a compact light-weight plasma source is produced for the generation of pulsed charged particle beams with current amplitude of 10-100 A, particle energy of 10-50 keV, pulse duration of 10⁻⁷-10⁻⁶ s and repetition rate of several tens of Hz. This source 100 induces an intense flux of ultraviolet and visible light radiation. Using an external electrode 140 as an anode grid that is grounded and the plasma cathode with negative polarity extracts and accelerates electrons and thus producing electron beam. Alternatively, using positive polarity on the anode grid 140 and grounding the cathode allows the extraction of ions. The anode 140 is driven by an accelerating voltage 141 and it is used to accelerate the extract charges. This anode 140 is designed transparent in the form of a grid through which the generated beam continues and be directed to the desired target 150 or test material. In FIG. 2 the emission of X-rays is shown where the interaction of the accelerated charged particles 200 with a metallic target 150 that is made of such materials as tungsten and molybdenum induces intense soft X-radiation 201.

The signal out to the ferroelectric cathode 173 is generated by the drive electronics is shown in FIG. 3. The diagram is shown that the diagram consists of a Krytron KN-22 180 with an anode 182, grid 183, and cathode 184. The other components of the driver include pulse transformer 175, 10KΩ resistor 189, diodes 188 and 185 where diode 185 is driven by TTL5-10 Volts. The input signal that drives the circuit is 500V dc 177 that is applied through a 10KΩ resistor 178. Other components of the circuit are 22MΩ resistor 186, capacitor 20 nF 188, 50Ω resistor 187.

The shape of the drive signal 110 determines the characteristics of the emitted charged particles and radiation 200. In order to enhance the performance of the disclosed source, the electron/ion yield is maximized by controlling the input voltage pulse shape applied to the ferroelectric cathode. For this purpose, in one modality a bipolar pulse can be used where two successive driving pulses have a selected time intervals between them. These pulses generate denser and uniform plasma by ionization of neutral particles resulting from desorption processes during the incomplete surface discharges.

The performance of the disclosed ferroelectric based source 100 is maximized by use of effective ferroelectric material, optimal shape of the driving pulse and the use of stack array and multiplexing of multiple FECs. The most important characteristic of the ferroelectric cathode 100 is the use of a material with a very high dielectric constant to produce dense surface plasma. The widely used ferroelectric materials, including BaTiO₃ and PZT, have dielectric constant of ε=1700 and ε=4000, respectively. Since the dielectric constant is a very important parameter for the current invention, using relaxor ferroelectric material such as PMN-PT enable stronger performance. PMN-PT has a very high dielectric constant on the order of ε=20000. Another benefit of the use of this material is the fact that its coercive field can be controlled at room temperature by selecting various levels of PT (Lead Titanate) content.

To take advantage of the capability of the ferroelectric cathode the following design parameters are used in the construction of the device:
1. Plasma parameters (plasma uniformity, plasma density, plasma electron temperature, plasma expansion velocity, charged particle energy distribution, etc.) are optimized as functions of the driving pulse parameters.
2. Electron/ion diode parameters (impedance, power and energy, potential distribution, etc.) are optimized as functions of the parameters of the induced plasma.
3. Maximum electron/ion current density is extracted without formation of explosive emission plasma.
4. Parameters of the extracted electron/ion beam (cross-sectional distribution of the electron current density, electron energy spectrum, electron beam divergence, etc.) are optimized.
5. The ferroelectric plasma cathode (active area of 10-cm²) is optimized with a driving power supply suitable for operation at frequency of 20 Hz, electron current density up to 10 A/cm² under an accelerating voltage of 30 kV and pulse duration of 50 ns.

The basic configuration of the ferroelectric cathode consists of a single wafer 100. Turning now to FIG. 4 and 5, where two modalities of the disclosed invention are shown for the use of plurality of ferroelectric cathodes where a stack and array of ferroelectric cathodes are used to enhance the source performance and increase the repetition rate. In one modality of parallel stack, a number of ferroelectric cathodes 250 are connected in parallel with a collective grid 251 placed next to the stack. In the second modality, an array of ferroelectric cathodes 252 are used. The schematic view of parallel stack and serial cathode modalities that are shown in FIG. 4 and 5 represent an example where ten connected ferroelectric cathodes. When using the parallel stack 250, essentially, the area of the active ferrosource is reduced leading to a lower current density however this effect is accompanied with excitations at a higher frequency. This approach is equivalent to the use of duty cycling as a means of enhancing the power efficiency. The use of an array 252, as shown in FIG. 5, reflects the use of ferroelectric cathodes in series, where a one-dimensional ferroelectric cathode set of ten elements is shown schematically. Other modalities can also be considered including combinations of parallel 250 and serial stacks 252 and arrays of ferroelectric cathode elements. Also, one can consider various sizes, spaces, and geometric configurations. The activation of the various elements can be made in a variety of possibilities including the activation of all of them simultaneously or in a programmable multiplexed sequence as determined effective for the specific application.

The operation of the Multiple-Radiations Source is shown schematically in FIG. 6 where the ferroelectric cathode 101 is shown to be supported with an external electrode with positive charge 20 to generate electron beam; using a similar external electrode with positive charge and a metallic target 30 X-rays are generated; using external electrode with negative charge 40 generate an ion beam; and by viewing selectively with no aids or with a UV filter 50, both visible light and ultraviolet radiation are formed.

A view of the combined components of the Multiple-Radiations Source is shown schematically in FIG. 7. The radiation source and the components are inside the chamber 80 and a vacuum pump 70 brings the vacuum to the level of at least 10⁻⁶ torr. The chamber 80 can also have a modality where the vacuum is brought to the required level and then chamber 80 is sealed and the pump70 is removed. The ferroelectric source 121 is produces plasma and a set of three carousels 63, 64 and 65 determine the type of radiation that is emitted. Carousel 63 contains optical radiation control elements that can include lenses, collimators, light filters and apertures. Also, an electrostatic lens can be one of its elements. Carousel 63 contains the target for the generation of X-rays and the type of this radiation can be controlled by choosing the target material 150. Some of the target materials can include Molybdenum, Copper and Silver. To control the emission of ions and electron beams carousel 65 is used. The produce radiation is determined by the element that is used where positive and negative grids as well as an aperture are provided on this carousel. The selected element on each of-the three carousels 63, 64 and 65 is controlled by a motor 66 that controls the specific carousel. The test material or sample 61 is subjected to the emitted radiation by the Multiple Radiation Source and detectors can be used to measure the reflected radiation 62 or the transmitted radiation 60.

The electron beam with energy of 40-50 keV and the X-ray radiation are to be emitted through a window 81 that is made of Beryllium that is 20-30 μm thick that is part of the vacuum chamber 80 located along the radiation beam path. For the ultraviolet and visible radiation a window 81 that is made of quartz is to be used. For the ion beam with an accelerating voltage of less than 100 kV, the test material or sample 61 should be placed inside the vacuum chamber 80.

What is claimed is:

1. Apparatus that produces plurality of radiation types that are generated by a ferroelectric cathode comprising of
a. ferroelectric disk that has continuous electrode on one side and modalities of electrode shapes on the other side including grid, strips and separated dots.
b. ferroelectric disk with high dielectric constant

2. The radiation emission device of claim 1, further comprising of an external electrode that extracts and accelerates charged particles from the produced plasma to generate plurality of radiation types

3. The radiation emission device of claim 1, comprising components that can be operated at high and low temperatures using ferroelectric disks that have a high Curie temperature that exceeds 1000° C.

4. The radiation emission device of claim 1, further comprising beam shaping components that determine the beam directivity, direction, intensity distribution and shape.

5. The radiation emission device of claim 1, further comprising drive electronics that provides pulses with various modalities including unipolar and bipolar shape.

6. The radiation emission device of claim 1, further comprising a modality with plurality of ferroelectric disk that provide strong radiation emission and provides source redundancy for high reliability.

7. The radiation emission device of claim 1, further comprising modalities with an array of ferroelectric electrodes that produce strong radiation emission and provides source redundancy for high reliability.
